(19) United States
(12) Patent Application Publication
(10) Pub. No.: US 2008/0219819 A1
(43) Pub. Date: Sep. 11, 2008

(54) Security compactor truck system

(76) Inventor: David E. Rajewski, Spokane, WA (US)

Correspondence Address: WELLS ST. JOHN P.S., 601 W. FIRST AVENUE, SUITE 1300, SPOKANE, WA, 99201, US

(21) Appl. No.: 11/716,380

(22) Filed: Mar. 9, 2007

(51) Int. Cl. B65F 3/02

(52) U.S. Cl. 414/409

(57) ABSTRACT

This invention includes in some embodiments a secure compactor truck system with a truck cab operationally attached to a truck chassis, a generally enclosed framework operationally attached to the chassis, the framework including a feedstock inlet and a feedstock outlet, a feedstock lift attached to one of the framework and the chassis, and disposed to lift feedstock containers to the feedstock inlet, and a normally closed secure feedstock inlet door which is configured to open when the feedstock lift provides a feedstock container to the feedstock inlet. Additional embodiments may further include a generally enclosed feedstock container compartment within the framework for storing at least one feedstock container.

### CROSS REFERENCE TO RELATED APPLICATION

This application does not claim priority from any other application.

### TECHNICAL FIELD

This invention pertains to a mobile and secure truck compactor system, preferably for use in the handling of paper and other feedstock.

### BACKGROUND OF THE INVENTION

Traditional compactor trucks such as garbage trucks and others have been around for many years to receive, compact, haul and dump paper, feedstock and garbage, among other items. With much of these documents, or feedstock, it is preferred for the particular application to haul the documents, paper or feedstock to a remote location for shredding or other disposal. During the loading, transportation and other handling of the documents, paper and feedstock, a higher level of security is desired or required to protect the information embodied in these documents and feedstock.

With traditional compactor trucks, such as garbage trucks, the paper is not secure and can blow out or escape and its contents available to others in the vicinity. With prior compactor trucks, it is also possible for third parties to gain access to the truck when it is temporarily unmanned or otherwise available for entry, because there is insufficient security or denial of access to the interior of the truck.

With more recent laws and regulations on security requirements for various types of documents and information (banking and health care records being two examples), it is more and more important for companies to be able to provide more secure hauling and/or compacting of documents and other feedstock requiring security.

It is therefore an object of one embodiment of this invention to provide a more secure compactor truck system for use in connection with loading and transporting documents and feedstock.

While the invention was motivated in addressing some objectives, it is in no way so limited. The invention is only limited by the accompanying claims as literally worded, without interpretative or other limiting reference to the specification, and in accordance with the doctrine of equivalents.

Other objects, features, and advantages of this invention will appear from the specification, claims, and accompanying drawings which form a part hereof. In carrying out the objects of this invention, it is to be understood that its essential features are susceptible to change in design and structural arrangement, with only one practical and preferred embodiment being illustrated in the accompanying drawings, as required.

### BRIEF DESCRIPTION OF THE DRAWINGS

Preferred embodiments of the invention are described below with reference to the following accompanying drawings.

FIG. 1 is an elevation view of one embodiment of a secure compactor truck as contemplated by this invention;

FIG. 2 is an elevation view of a loading mechanism system for one embodiment of a secure compactor truck as contemplated by this invention;

FIG. 3 is a top view of the compactor enclosure portion of the embodiment of the invention illustrated in FIG. 1;

FIG. 4 is a rear elevation view of the trailer portion of a secure compactor truck as contemplated by this invention;

FIG. 5 is a partial top view of the front portion of the trailer of the embodiment of the invention illustrated in FIG. 1;

FIG. 6 is an elevation view of the front portion of the embodiment of the invention illustrated in FIG. 5;

FIG. 7 is a rear elevation partial cutaway view of the embodiment of the invention illustrated in FIG. 1;

FIG. 8 is a front elevation view of one embodiment of a container loading system which may be utilized in this invention; and

FIG. 9 is a side elevation view of a rear loading embodiment of this invention.

### DETAILED DESCRIPTION OF THE PREFERRED EMBODIMENTS

Many of the fastening, connection, manufacturing and other means and components utilized in this invention are widely known and used in the field of the invention described, and their exact nature or type is not necessary for an understanding and use of the invention by a person skilled in the art or science; therefore, they will not be discussed in significant detail. Furthermore, the various components shown or described herein for any specific application of this invention can be varied or altered as anticipated by this invention and the practice of a specific application or embodiment of any element may already be widely known or used in the art or by persons skilled in the art or science; therefore, each will not be discussed in significant detail.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

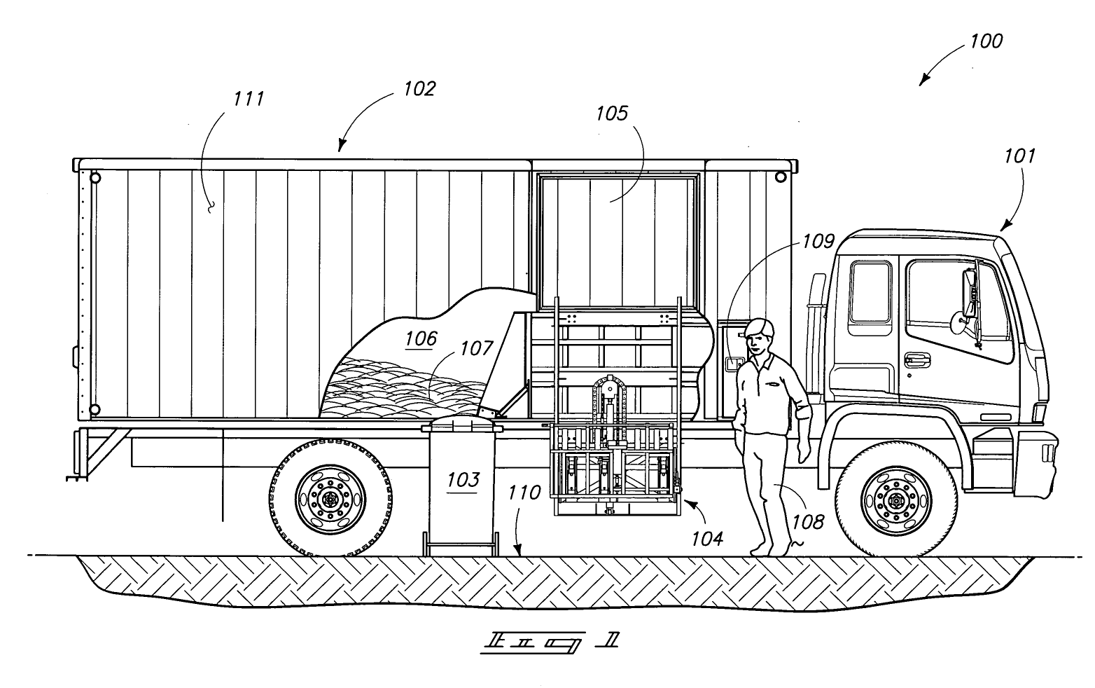

FIG. 1 is an elevation view of one embodiment of a secure compactor truck 100 as contemplated by this invention, illustrating vehicle cab 101, secure compactor enclosure 102 with enclosure sidewall 111, input door 105, control panel 109, operator 108 and lift mechanism 104. An exemplary bin 103 is shown on the ground 110, with lift mechanism 104 mounted to the side of the truck 100 to engage, secure, lift and dump bin 103 through the aperture created when input door 105 is opened. The secure compactor enclosure 102 may also be referred to as a generally enclosed framework operationally attached to the chassis, the framework including a feedstock inlet and a feedstock outlet.

FIG. 1 further shows secure compactor enclosure 102 with internal cavity 106 and feedstock 107 within internal cavity 106, which may be any one or more of a number of different items being picked up and hauled. FIG. 1 shows the input door 105 or feedstock inlet in its normally closed position, which provides a level of security to the contents of the internal cavity 106.

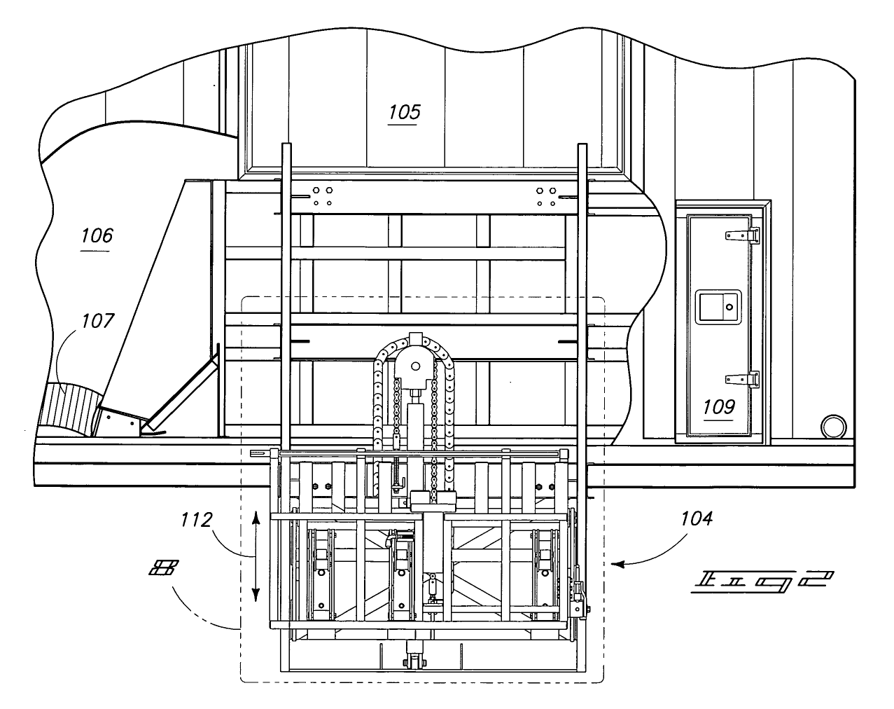

FIG. 2 is an elevation view of one example of a loading mechanism system which may be utilized in some embodiments of this invention for a secure compactor truck 100. It will be appreciated by those of ordinary skill in the art that no particular lift mechanism is required to practice aspects or embodiments of this invention, but instead any one of a number of different types and kinds of lift mechanisms may be utilized, all within the contemplation of various embodiments of this invention.

FIG. 2 illustrates movement arrow 112 to illustrate how lift mechanism may be extended downward to ground level, or to upward to any one of a number of different levels to store it or to engage any one of a number of different feedstock bins sizes and configurations. The lift mechanism 104 may generally be utilized to lift, dump and lower bins and containers relative to the interior cavity 106 of the compactor enclosure 102. In embodiments of this invention, input door 105 is on a hydraulic system and when bin 103 is to be dumped into the compactor enclosure 102, the hydraulic system (shown in later figures) will cause input door 105 to move inwardly to open an aperture to facilitate the dumping of feedstock from feedstock bins into the compactor enclosure 102. The interior cavity 106 is shown with feedstock 107 therein.

As feedstock is dumped within the interior cavity, a ram may be utilized in some embodiments of this invention to move the feedstock in the desired direction, such as toward the rearward side of the secure compactor vehicle 100 embodiment shown in FIG. 1.

It will be appreciated by those of ordinary skill in the art, that the input door 105 may be located at any one or more of a number of different locations around the compactor enclosure, with no one in particular being required to practice this invention. For instance, it is anticipated that a rear loading input door may be utilized for certain embodiments such as for loading dock loading and unloading, wherein the input door and the lift mechanism would be located at the rear side or rear end of the compactor enclosure. In such an embodiment, the ram or other movement mechanism would push the feedstock toward the front of the vehicle. This type of rear loading configuration may be helpful for loading dock and other applications, again, all within the contemplation of this invention. FIG. 2 also shows control box 109, which may be accessed by operator 108.

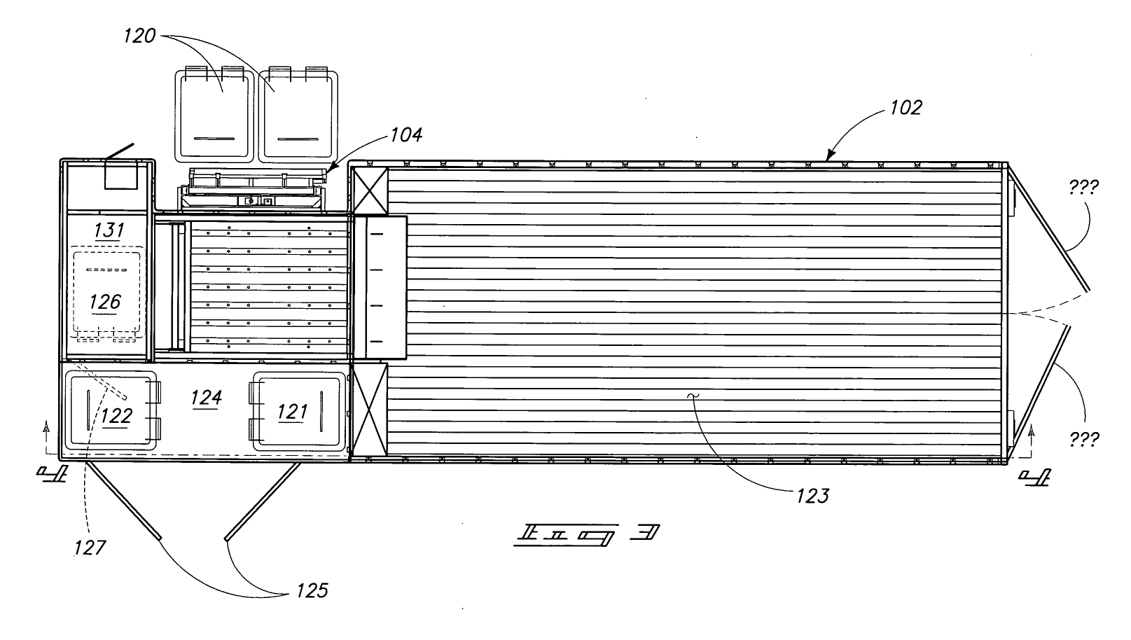

FIG. 3 is a top view of the secure compactor enclosure 102 of the embodiment of the invention illustrated in FIG. 1. FIG. 3 illustrates compactor enclosure 102 with top wall 123, rear doors 121, bin storage area 124 with bin 121 and bin 122 shown therein, with bin storage doors 125 providing access to bin storage area 124.

FIG. 3 further illustrates two bins 120 positioned for lifting by lift mechanism 104 to a position where it can be dumped or placed through the input door and into the interior cavity of the compactor enclosure 102. FIG. 3 further shows bin 126 within storage area 131 and access door 127 providing access thereto.

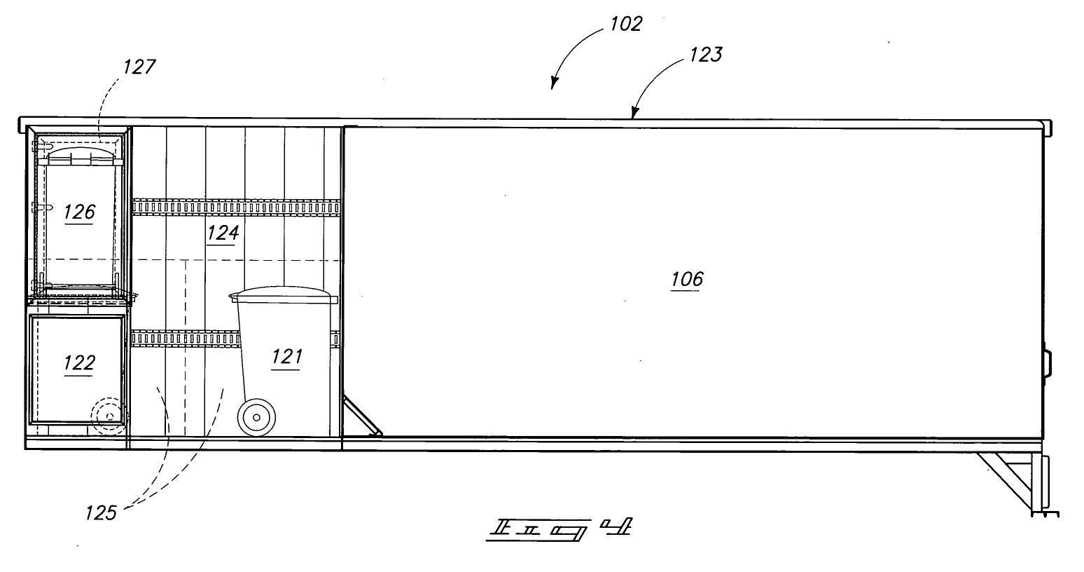

FIG. 4 is a rear elevation view of the compactor enclosure 102 embodiment illustrated in FIG. 1. FIG. 4 illustrates bin 126 within storage compartment 131 and access door 127 in hidden lines. Bin 122 and bin 121 are shown within bin storage 124 and doors 125 have been omitted for purposes of the drawing. FIG. 4 further illustrates top wall 123 and internal cavity 106.

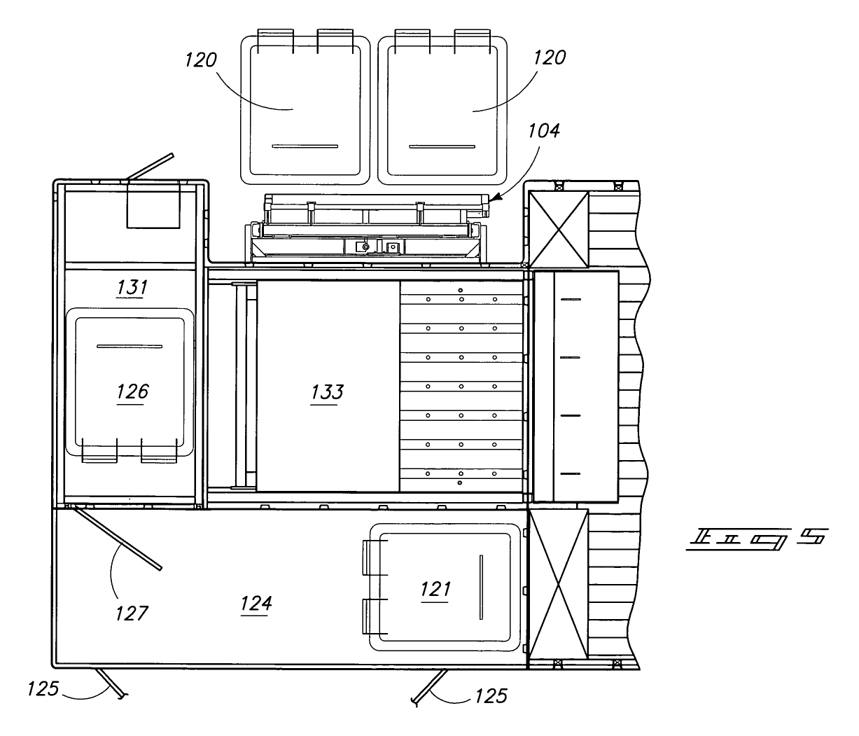

FIG. 5 is a partial top view of the front portion of the secure compactor enclosure 102 illustrated in prior figures, showing bin 121 within bin storage area 124 and bin storage area doors 125 shown open. Second bin storage area 131 is shown with bin 126 therein and storage door 127, which may be swung open for access to the compartment housing bin 126.

Two bins 120 are shown loaded on lift mechanism 104. Input area 133 is the location in this embodiment where the feedstock is initially placed for movement toward the interior cavity of the secure compactor enclosure 102.

It will be appreciated by those of ordinary skill in the art that the bin and other storage areas may be located at any one or more of numerous different locations within or around the compactor enclosure 102, with no one or more in particular being required to practice embodiments of the invention.

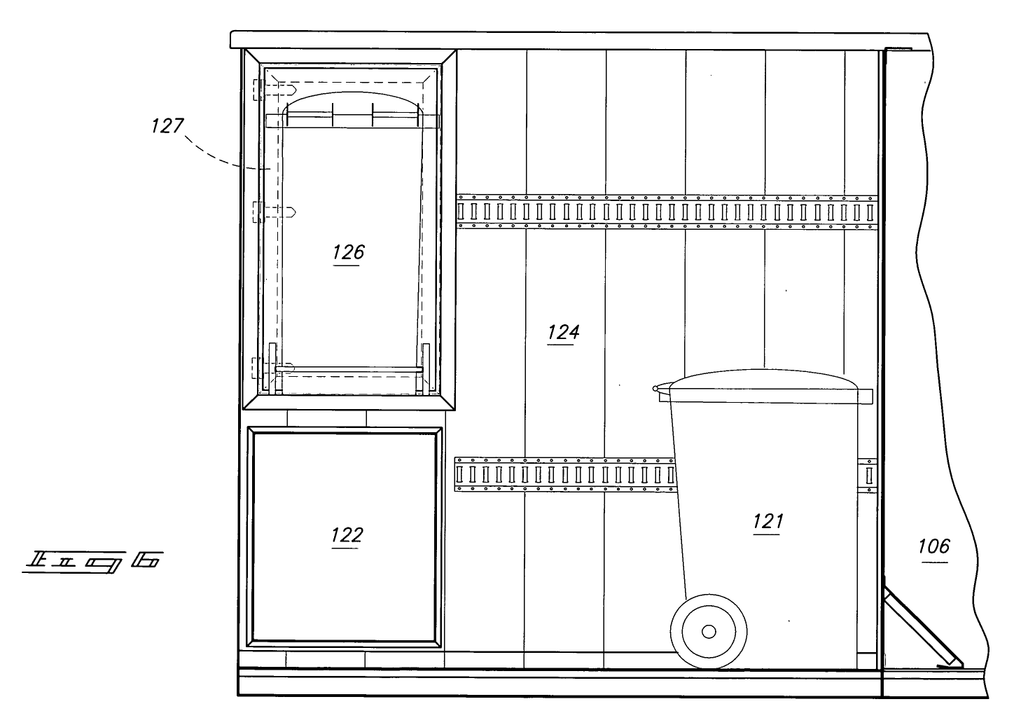

FIG. 6 is an elevation view of the front portion of the secure compactor enclosure 102 illustrated in the figures above, showing the forward portion of the enclosure in this embodiment. FIG. 6 illustrates storage compartment door 127, bin 121 within bin storage compartment 124 and the interior cavity 106 of the secure compactor enclosure 102.

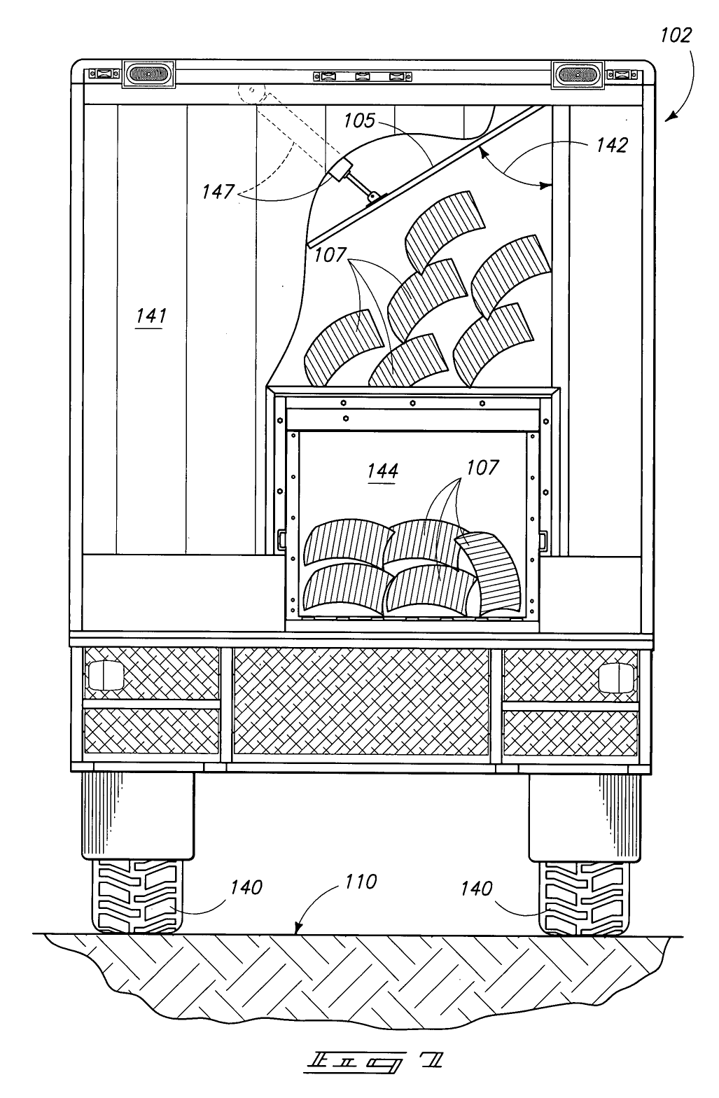

FIG. 7 is a side elevation partial cutaway view of the secure compactor enclosure 102 shown in figures above. FIG. 7 illustrates input door 105 opened by hydraulics or ram 147 as shown by movement arrow 142 to allow feedstock 107 to be dumped or placed within the compactor enclosure 102. Feedstock 107 may then be hoppered or moved away from the input door to allow more feedstock 107 to enter the compactor enclosure 102. The rear wall 141 of the compactor enclosure 102 is shown, as are tires 140 for movement of the vehicle.

It will be appreciated by those of ordinary skill in the art how ram 147 may be utilized to provide a more secure compactor truck such that the interior cavity secure compactor enclosure 102 would be inaccessible from outside of the truck, if the truck is left unattended. The default for programming and control of the position of the input door may be to locate it in the closed position, which may be accomplished by the extension of ram 147.

In prior art compactor trucks, one reason the rear enclosure is not secure is because the input door or area is open or not securely held in the close position, making the interior of the enclosure vulnerable for intrusion. Prior compactor trucks are typically instead accessible and provide an aperture. through which feedstock may escape and be lost. Ram wall 144 may be utilized in a reciprocating manner to move feedstock 107 from the front area of the compactor enclosure 102 to the rear area. It would be appreciated by those of ordinary skill in the art that if a rear loader is utilized, that the movement of the feedstock would be from the rear of the truck toward the front.

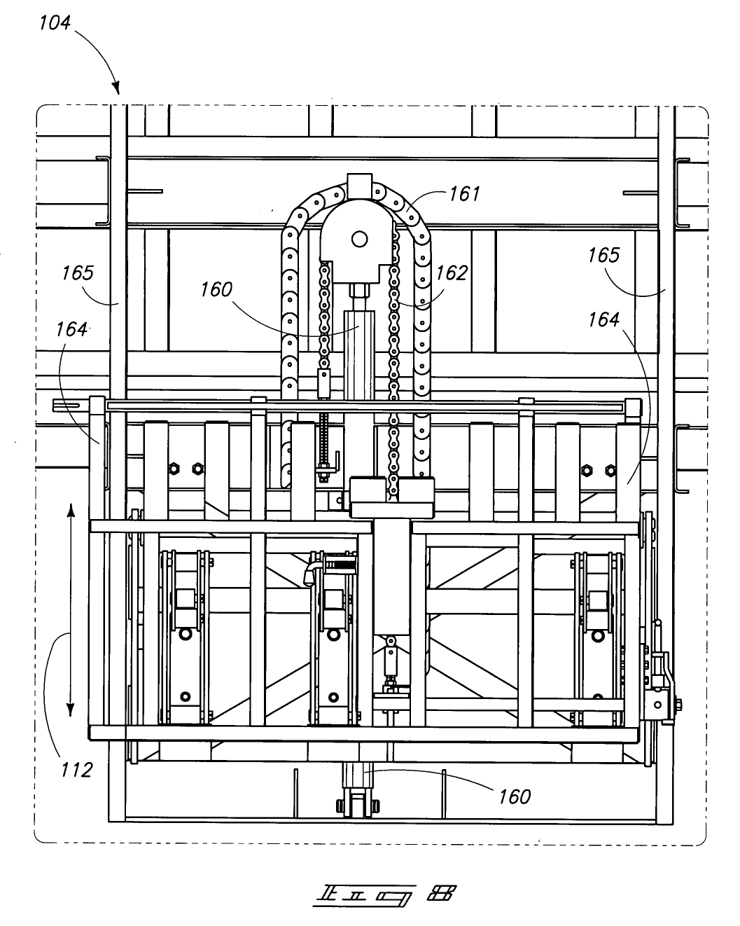

FIG. 8 is a front elevation view of one embodiment of a container loading system or lifting mechanism 104, which may be utilized in embodiments of this invention. FIG. 8 shows primary ram 160 configured to vertically move, thereby causing the lift mechanism 104 to move upward or downward based on whatever control is being exercised, on rails 165. Primary lift chain 162 and secondary lift chain 163 are utilized to transfer movement from lift ram 160 to lift mechanism framework 164 as shown by movement arrow 112.

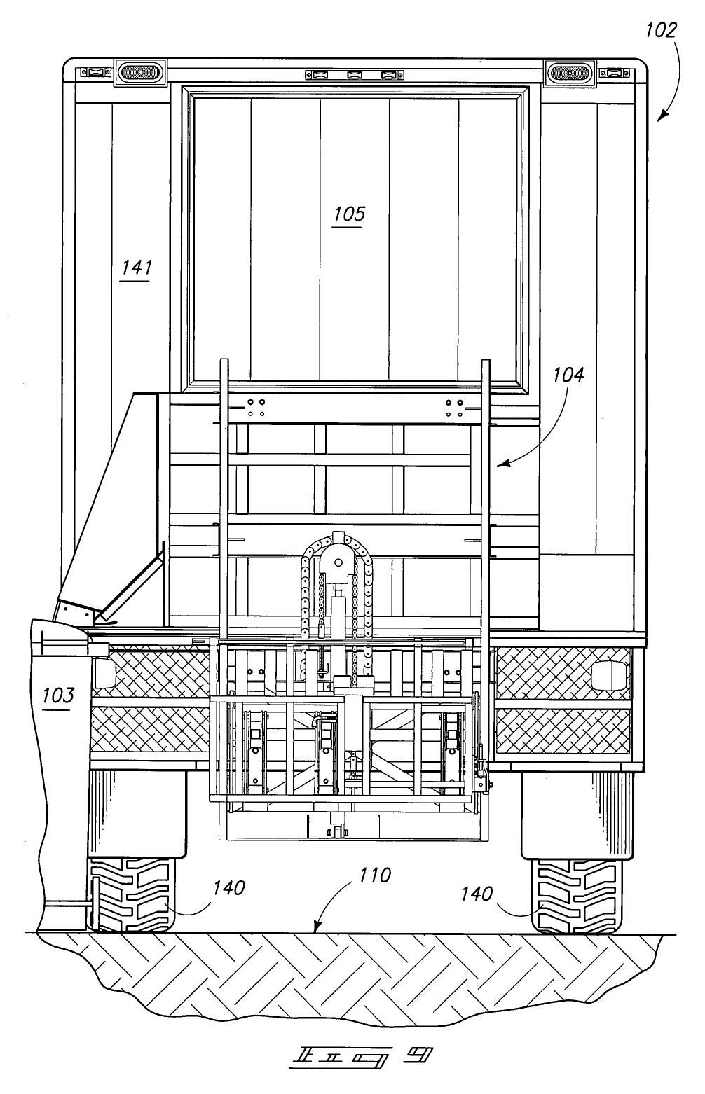

FIG. 9 is a side elevation view of a rear loading embodiment of this invention, illustrating secure compactor enclosure 102, rear input cover 105, rear wall 141, tires 140 on ground 110. A bin 103 is shown next to the vehicle as well as an exemplary lift mechanism 104. A rear loading environment for example may be preferable for applications wherein the vehicle services a loading dock arrangement in which the loading surface is elevated above the ground service.

It will be appreciated by those of ordinary skill in the art that the same or similar mechanisms, components or elements that are utilized for the embodiment in which the feedstock is loaded from the side of the enclosure may also be utilized for the rear loading embodiment. The rear loading embodiment would still have the storage areas and compartments as the side loading embodiment, either located in the same places or altered depending on the application.

As will be appreciated by those of reasonable skill in the art, there are numerous embodiments to this invention, and variations of elements and components which may be used, all within the scope of this invention.

One embodiment of this invention, for example, is a secure compactor truck system comprised of: a truck cab operationally attached to a truck chassis; a generally enclosed framework operationally attached to the chassis, the framework including a feedstock inlet and a feedstock outlet; a feedstock lift attached to one of the framework and the chassis, and disposed to lift feedstock containers to the feedstock inlet; and a normally closed secure feedstock inlet door which is configured to open when the feedstock lift provides a feedstock container to the feedstock inlet. Another or further embodiment may be one which further comprises a generally enclosed feedstock container compartment within the framework for storing at least one feedstock container.

Other and additional embodiments may be ones: wherein the truck chassis is configured to support the enclosed framework; wherein the truck chassis is configured to allow a trailer including the enclosed framework to be operationally attached to the truck chassis; and/or wherein the truck chassis is configured to allow a trailer including the enclosed framework to be operationally attached to the truck chassis.

Still further embodiments may be wherein: the enclosed framework includes a first end, a second end, a first side and a second side, and further wherein the feedstock inlet is on the first side and the feedstock outlet is on the second end the comprising a fully enclosed feedstock container compartment; and/or further wherein the feedstock inlet door is configured to open inwardly into the framework.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. A secure compactor truck system comprised of:
a truck cab operationally attached to a truck chassis;
a generally enclosed framework operationally attached to the chassis, the framework including a feedstock inlet and a feedstock outlet;
a feedstock lift attached to one of the framework and the chassis, and disposed to lift feedstock containers to the feedstock inlet; and
a normally closed secure feedstock inlet door which is configured to open when the feedstock lift provides a feedstock container to the feedstock inlet.

2. A secure compactor truck system as recited in claim 1, and further comprising a generally enclosed feedstock container compartment within the framework for storing at least one feedstock container.

3. A secure compactor truck system as recited in claim 1, and further wherein the truck chassis is configured to support the enclosed framework.

4. A secure compactor truck system as recited in claim 1, and further the truck chassis is configured to allow a trailer including the enclosed framework to be operationally attached to the truck chassis.

5. A secure compactor truck system as recited in claim 1, and wherein the enclosed framework includes a first end, a second end, a first side and a second side, and further wherein the feedstock inlet is on the first side and the feedstock outlet is on the second end.

6. A secure compactor truck system as recited in claim 1, and further wherein the comprising a fully enclosed feedstock container compartment 7. A secure compactor truck system as recited in claim 1, and further wherein the feedstock inlet door is configured to open inwardly into the framework.
